(19) United States
(12) Patent Application Publication
(10) Pub. No.: US 2010/0009798 A1
(43) Pub. Date: Jan. 14, 2010

(54) HYDRAULICALLY ACTUATED ELECTRONIC LIMITED SLIP DIFFERENTIAL FOR FRONT WHEEL DRIVE VEHICLES

(75) Inventors: Robert Keller, Chesterfield, MI (US); Eric C. Sandstrom, Oxford, MI (US)

Correspondence Address: BorgWarner/BHGL, 524 South Main Street, Suite 200, Ann Arbor, MI, 48104, US

(73) Assignee: BORGWARNER INC., Auburn Hills, MI (US)

(21) Appl. No.: 12/373,349

(22) PCT Filed: Jul. 6, 2007
(86) PCT No.: PCT/US07/72934

§ 371 Date: Sep. 15, 2009

Related U.S. Application Data
(60) Provisional application No. 60/830,950, filed on Jul. 14, 2006.

(51) Int. Cl. F16H 48/20

(52) U.S. Cl. 475/86

(57) ABSTRACT

A differential system for a front wheel drive vehicle. The differential system includes a differential carrier (24), an actuator housing {44), an intermediate shaft (32), a clutch pack (42), and a piston (40). The differential carrier (24) houses a differential assembly (16) configured to drive a right and left axle shaft. The actuator housing (44) is configured to rotate in conjunction with the differential carrier (24). The intermediate shaft (32) extends through the actuator housing (44). The clutch pack (42) has a first set of clutch plates (46) that engage the actuator housing (44} and a second set of clutch plates (48) that engage the intermediate shaft (32). The piston (40) compresses the first and second set of clutch plates {46, 48) thereby frictionaiiy coupling the differential carrier (24) to the intermediate shaft (32) and thus locking or modulating the differential.

### FIELD OF THE INVENTION

This invention relates to a limited slip differential assembly particularly adapted for front wheel drive vehicle applications.

### BACKGROUND OF THE INVENTION

Conventional rear-wheel drive motor vehicles provide wheel driving torque through a propeller shaft coupled to left and right axles through a differential. Front-wheel drive vehicles couple to front wheel drive axles through a differential driven by a transaxle. Four-wheel drive and so-called all-wheel drive vehicles also use differentials to drive front and rear axles. Differentials allow differences in wheel rotational speed to occur between the left and right side driven axles. The earliest and most basic designs of differentials are known as open differentials in that they provide constant torque between the two axles and do not operate to control the relative rotational speed between the axle shafts. A well known disadvantage of open differentials occurs when one of the driven wheels engages the road surface with a low coefficient of friction (μ) with the other having a higher μ. In such case, the low tractive effort force developed at the low μ contact surface prevents significant torque from being developed on either axle. Since the torque between the two axle shafts is relatively constant, little total tractive effort can be developed to pull the vehicle from its position. Similar disadvantages occur in dynamic conditions when operating, especially in low μ or so-called split μ driving conditions.

The above limitations of open differentials are well known and numerous design approaches have been employed to address such shortcomings. One approach is known as a locking differential. These systems are typically mechanically or hydraulically based or use other strategies to attempt to couple the two axle shafts together to rotate at nearly a constant speed. Thus, in this operating condition, the two axles are not mutually torque limited. A mechanically based locking differential typically uses a clutch pack or friction material interface which locks the two axles together when a speed difference between the axles is detected. Other systems incorporate fluid couplings between the axles which provide a degree of speed coupling.

Providing a limited slip or locking type differentials for front wheel drive vehicle applications poses particularly stringent packaging limitations. The presence of engine, transmission, transaxle axle shafts, suspension and steering components all within the front engine compartment of the vehicle provide little packaging space for additional power train components.

### BRIEF SUMMARY OF THE INVENTION

The hydraulically actuated electronic limited slip differential in accordance with the present invention is especially adapted for front wheel drive applications and can be directly coupled to the open differential of the vehicle transaxle. A central intermediate shaft passes through the unit from the differential to one of the front drive shafts through a universal or constant velocity type flexible torque coupling joint. A clutch pack is compressed to couple or decouple the differential carrier to one of the axle shafts through an intermediate shaft which can provide a locking, or modulating condition between the two front drive shafts.

These and other aspects and advantages of the present invention will become apparent upon reading the following detailed description of the invention in combination with the accompanying drawings.

### BRIEF DESCRIPTION OF THE DRAWINGS

FIG. 1 is a schematic view of actuation system for a locking, or modulating differential in accordance with one embodiment of the present invention;

FIG. 2 is a sectional view of one embodiment of actuation system of FIG. 1; and

FIG. 3 is a schematic view of an actuation system according to another embodiment.

### DETAILED DESCRIPTION OF THE INVENTION

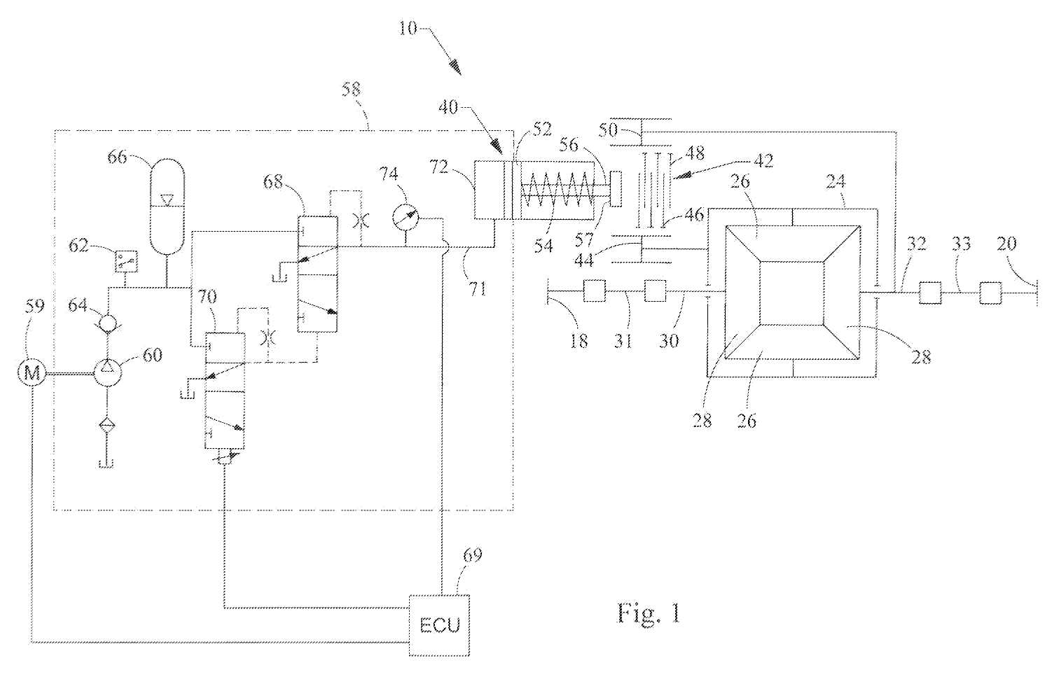

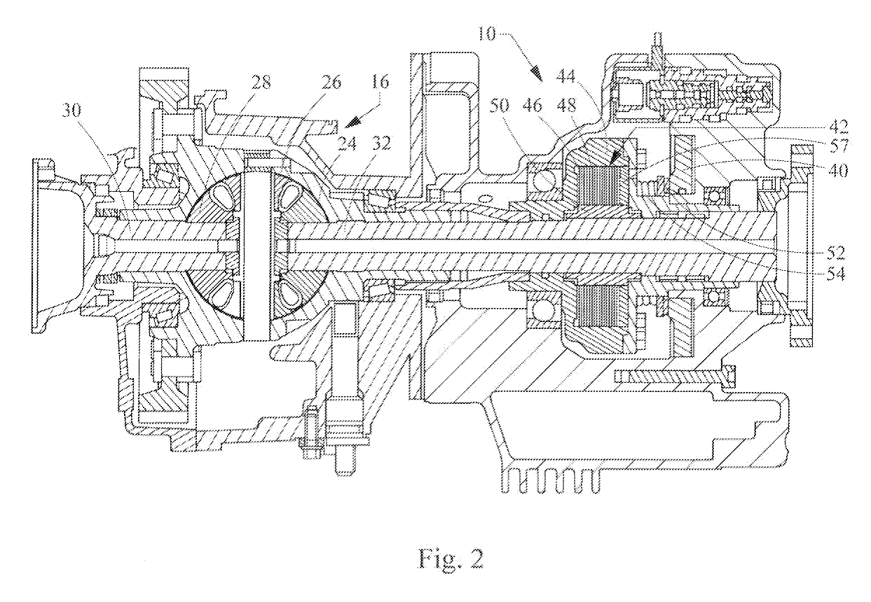

An actuation system for a limited slip differential assembly is provided in FIGS. 1 and 2. The actuation system is generally denoted by reference 10.

The differential assembly 16 includes basic elements of typical differential assemblies, which include a differential carrier 24 which is driven by the vehicle's transmission output via a gear or chain drive (not shown). A pair of planet gears 26 are rotatable about a common differential shaft mounted to the carrier. Planet gears 26 mesh with a pair of side gears 28 which are in turn splined or otherwise connected with a pair of axle shafts 31,33 through intermediate shafts 30, 32 for the left and right hand wheels 18, 20 of the associated motor vehicle. The above described components of differential assembly 16 are common components of so-called open differentials. Front wheel drive vehicles may also use a differential which is a planetary gear set.

Under certain low traction conditions it may be desirable to lock, or modulate the differential assembly 18 providing a constant, or limited slip speed between two axle shafts 31, 33. Accordingly, the actuation system 10 includes a piston 40 and a clutch pack 42. The piston 40 is hydraulically actuated and does not rotate. In contrast, differential carrier 24 and the intermediate shaft 32 each rotate with regard to the stationary piston 40. Under normal operating conditions, the differential carrier 24 and the intermediate shaft 32 are allowed to rotate at different speeds. Actuator housing 44 is attached to the differential carrier 24 and rotates with the differential carrier 24. The clutch pack 42 includes two sets of clutch plates 46, 48. The first set of clutch plates 46 engage the actuator housing 44 through a splined connection and, therefore, rotates with the differential carrier 24. The second set of clutch plates 48 engage a shaft portion 50 in a splined connection that is attached to and rotates with the intermediate shaft 32. Typically, the first set of clutch plates 46 is interleaved with the second set of clutch plates 48 to maximize the active frictional surface area in the clutch pack 42.

To provide a constant, or limited slip speed between the axle shafts 31 and 33, the actuation system 10 frictionally locks, or limits the speed difference between the intermediate shaft 32 to the differential carrier 24 through the clutch pack 42. To lock, or modulate the intermediate shaft 32 to the differential carrier 24, the piston 40 is hydraulically actuated to extend and apply force to thrust bearing 52. The thrust bearing 52 acts against pins 56 that compresses the first and second set of clutch plates 46 and 48, thereby frictionally coupling or limiting the slip speed between the intermediate shaft 32 to the differential carrier 24. To once again operate in a open differential mode, the hydraulic pressure is relieved and a spring 54 acts to relieve pressure on pins 56 and, consequently, the piston 40 allowing the clutch plates 46 and 48 to rotate independently. In addition, if is readily contemplated that the pin 56 and spring 54 may be eliminated such that the piston 40 acts on the clutch pack 42 directly through the thrust hearing 52.

The hydraulic circuit 58 is used to control the actuation of the piston 40. A hydraulic pump 60 creates a hydraulic system pressure that is provided to a pressure regulator switch 62 through a check valve 64. If the hydraulic system pressure falls below a minimum pressure, the pressure regulator switch 62 activates the motor 59, thereby driving the hydraulic pump 60 to increase the hydraulic system pressure above the minimum pressure. In addition, the flow from the hydraulic pump 60 feeds a pressure accumulator 66. The pressure accumulator 66 maintains a constant system pressure in response to a transient demand for fluid, for example when driving the piston 40. The pressure accumulator 66 is in fluid communication with a primary valve 70 and a secondary valve 68. When activated, the secondary valve 68 provides hydraulic to flow chamber 72 driving piston 40 forward to compress the clutch plates 46, 48 of the clutch pack 42. The primary valve 70 provides a signal level pressure feed to valve 68 in order to control the pressure delivered to the piston 40.

An electronic control unit 69 is in electrical communication with a solenoid of the primary valve 70. The amount of current provided to the solenoid by the electronic control unit 69 controls the amount of pressure provided to the secondary valve 68. As such, the secondary valve 68 may be a spool valve such that the pressure from the primary valve 70 creates a force balance between the pressure from the primary valve 70 and a hydraulic feedback loop in communication with the output or piston side of the secondary valve 68. Accordingly, the force balance causes a balancing of the spool in the spool valve implementation, thereby controlling hydraulic pressure delivered to the piston 40. In addition, a pressure sensor 74 is in electrical communication with the electronic control unit 69. The pressure sensor 74 is in fluid communication with the hydraulic line 71 between the secondary valve 68 and the chamber 72 of the piston 40. Accordingly, the pressure sensor 74 generates an electronic signal based on the pressure driving the piston 40 and forms an electronic feedback loop to the electronic control unit 69. The electronic feedback loop may be used by the electronic control unit 69 to adjust the current provided to the solenoid of the primary valve 70 creating a variable pressure control loop. With the pressure to the piston 40 being variably adjustable, the piston 40 may provide an adjustable actuation pressure to the clutch pack 42 to variably control the friction engagement of the clutch plates 46, 48 and hence the locking or modulation between the differential carrier 24 and the intermediate shaft 32.

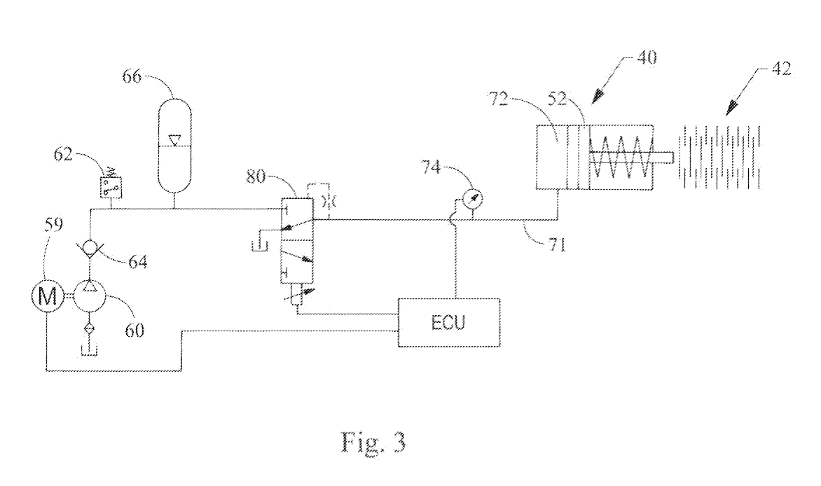

The system may also be implemented using a single valve design, as shown in FIG. 3. Accordingly, the pressure accumulator 66 is in fluid communication with a valve 80. When activated, the valve 80 provides hydraulic pressure to flow chamber 72 driving piston 40 forward to compress the clutch plates of the clutch pack 42.

An electronic control unit 69 is in electrical communication with a solenoid of the valve 80. The amount of current provided to the solenoid by the electronic control unit 69 controls the amount of pressure provided through the valve 80, thereby controlling hydraulic pressure delivered to the piston 40. In addition, a pressure sensor 74 is in electrical communication with the electronic control unit 69. The pressure sensor 74 is in fluid communication with the hydraulic line 71 between the valve 80 and the chamber 72 of the piston 40. Accordingly, the pressure sensor 74 generates an electronic signal based on the pressure driving the piston 40 and forms an electronic feedback loop to the electronic control unit 69. The electronic feedback loop may be used by the electronic control unit 69 to adjust the current provided to the solenoid. As described above, the piston 40 may provide an adjustable actuation pressure to the clutch pack 42 to variably control the friction engagement of the clutch plates and hence the locking or modulation between the differential carrier 24 and the intermediate shaft 32.

As a person skilled in the art will readily appreciate, the above description is meant as an illustration of implementation of the principles this invention. This description is not intended to limit the scope or application of this invention in that the invention is susceptible to modification, variation and change, without departing from the spirit of this invention, as defined in the following claims.

1. A differential system for controlling torque in a powertrain of a motor vehicle comprising:
a differential carrier (24) in communication with a differential assembly (16);
an actuator housing (44) configured to rotate in conjunction with the differential carrier (24);
a first intermediate shaft (32) extending through the actuator housing (44) and coupled with a first wheel (20);
a second intermediate shaft (30) in communication with the differential assembly (16) and coupled to a second wheel (18);
a clutch pack (42) for frictionally coupling the differential carrier (24) to the first intermediate shaft (32), the clutch pack (42) including a first set of clutch plates (46) engaging the actuator housing (44) and a second set of clutch plates (48) engaging the first intermediate shaft (32);
a piston (40) to compress the first and second set of clutch plates (46, 48) thereby frictionally coupling the differential carrier (24) to the first intermediate shaft (32).

2. The system according to claim 1, further comprising a thrust bearing (52) in communication with the piston (40) and configured to drive a pin (56) into the clutch pack (42) thereby compressing the first and second set of clutch plates (46, 48).

3. The system according to claim 1, further comprising a hydraulic circuit (58) configured to actuate the piston (40).

4. The system according to claim 3, further comprising a spring (54) configured to retract the piston (40) when pressure is released by the hydraulic circuit (58).

5. The system according to claim 3, wherein the hydraulic circuit (58) includes an accumulator (66) and at least one hydraulic valve (70) for manipulating the piston (40), the accumulator (66) being configured to provide a constant pressure to at least one hydraulic valve (70).

6. The system according to claim 3, wherein the hydraulic circuit (58) includes a secondary valve (68) configured to provide a variable pressure to the piston (40).

7. The system according to claim 6, wherein the hydraulic circuit (58) includes a primary valve (70) having a solenoid configured to provide a variable pressure feed to the secondary valve (68) based on a solenoid current.

8. The system according to claim 3, wherein the hydraulic circuit (58) includes a pressure sensor (74) configured to sense the pressure driving the piston (40) to create an electronic feedback loop.

9. The system according to claim 1, wherein the first set of clutch plates (46) are splined to the actuator housing (44) and the second set of clutch plates (48) are splined to the first intermediate shaft (32).

10. A differential system for a front wheel drive vehicle, the differential system comprising:
a differential carrier (24) in communication with a differential assembly (16);
an actuator housing (44) configured to rotate in conjunction with the differential carrier (24);
a first intermediate shaft (32) extending through the actuator housing (44) and coupled with a first front wheel (20);
a second intermediate shaft (30) in communication with the differential assembly (16) and coupled to a second front wheel (18);
a clutch pack (42) configured to frictionally couple the differential carrier (24) to the first intermediate shaft (32), the clutch pack (42) including a first set of clutch plates (46) engaging the actuator housing (44) and a second set of clutch plates (48) engaging the first intermediate shaft (32);
a piston (40) actuated by a hydraulic circuit (58) and coupled to a pin (56) in the clutch pack (42) through a thrust bearing (52), the pin (52) being configured to compress the first and second set of clutch plates (46, 48) thereby frictionally coupling the differential carrier (24) to the first intermediate shaft (32) in response to actuation of the piston (40) by the hydraulic circuit (58);
a spring (54) configured to retract the piston (40) thereby releasing the clutch plates (46, 48) when the hydraulic circuit (58) relieves pressure from against the piston (40).

11. The system according to claim 10, wherein the hydraulic circuit (58) includes an accumulator (66) and at least one hydraulic valve (70) for manipulating the piston (40), the accumulator (66) being configured to provide a constant pressure to the at least one hydraulic valve (70).

12. The system according to claim 10, wherein the hydraulic circuit (58) includes a secondary valve (68) configured to provide a variable pressure to the piston (40).

13. The system according to claim 13, wherein the hydraulic circuit (58) includes a primary valve (70) having a solenoid configured to provide a variable pressure on the secondary valve (68) based on a solenoid current.

14. The system according to claim 10, wherein the hydraulic circuit (58) includes a pressure sensor (74) configured to sense the pressure driving the piston (40) to create an electronic feedback loop.

15. The system according to claim 10, wherein first set of clutch plates (46) are splined to the actuator housing (44) and the second set of clutch plates (48) are spliced to the first intermediate shaft (32).
